(19) United States
(12) Patent Application Publication
(10) Pub. No.: US 2026/0230444 A1
(43) Pub. Date: Aug. 6, 2026

(54) REAL-TIME MESSAGE CLASSIFICATION QUALITY EVALUATION FOR A COMMUNICATION SERVICES PLATFORM

(71) Applicant: Twilio Inc., San Francisco, CA (US)

(72) Inventors: Sachin Narayan Nagargoje, Bengaluru (IN); Samarpan Das, Bangalore (IN); Sayantan Das, Bengaluru (IN); Sumanth Pulugu, Hyderabad (IN); Shamik Ray, Kolkata (IN)

(21) Appl. No.: 19/044,878

(22) Filed: Feb. 4, 2025

(51) Int. Cl. H04L 51/212; G06N 20/00

(52) U.S. Cl. CPC H04L 51/212; G06N 20/00

(57) ABSTRACT

A method for real-time classification quality evaluation for a communication services platform includes receiving one or more messages to be transmitted to respective destinations. The method includes determining, using a first AI model, a corresponding first message category for each message of the one or more messages. The method includes determining, using a second AI model, a corresponding second message category for each message of the one or more messages. The method includes determining a value of a performance metric of the first AI model by comparing, for each message, the corresponding first message category and the second message category. The method includes, responsive to determining that the value of the performance metric does not satisfy a predefined quality condition, modifying one or more parameters of the first AI model to improve a value of a performance metric of the first AI model.

### TECHNICAL FIELD

Aspects and implementations of the disclosure relate to computer software, and more specifically, to systems and methods for real-time message classification quality evaluation for a communication services platform.

### BACKGROUND

Entities can use communication services platforms to manage their communications, for example, via text messages. A communication services platform may classify text messages sent by entities. The classification may assist the communication services platform in determining a use case of the message and determining whether the message complies with the platform's acceptable use policy or applicable laws and regulations.

### BRIEF DESCRIPTION OF THE DRAWINGS

Aspects and implementations of the disclosure will be understood more fully from the detailed description given below and from the accompanying drawings of various aspects and implementations of the disclosure, which, however, should not be taken to limit the disclosure to the specific aspects or implementations, but are for explanation and understanding.

FIG. 1 illustrates an example system architecture for real-time message classification quality evaluation for a communication services platform, in accordance with some implementations of the disclosure.

FIG. 2 illustrates an example flow of data for real-time message classification quality evaluation for a communication services platform, in accordance with some implementations of the disclosure.

FIG. 3 depicts a flow diagram of an example method for real-time message classification quality evaluation for a communication services platform, in accordance with some implementations of the disclosure.

FIG. 4 is a block diagram illustrating an exemplary computer system, in accordance with some implementations of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as short message service (SMS) messages, multimedia messaging service (MMS) messages, Rich Communication Services (RCS) messages, and/or instant messaging (IM) messages, to and from devices via various communication channels. The communication services platform can offer voice call service tools that facilitate voice conversations, e.g., the making and receiving of voice calls using various protocols, such as Voice over Internet Protocol (VoIP), various mobile communications protocols, or Session Initiation Protocol (SIP).

In some jurisdictions, applicable law may prohibit sending messages related to certain use case-based categories during a certain time range (e.g., sending marketing messages between 8 p.m. and 8 a.m. local time of the recipient). In order to prevent possible violations of such laws or regulations, or in order to enforce the communication services platform's acceptable use policy or other types of policies, the platform may classify the messages being transmitted and use the message classifications for determining whether a particular message may be transmitted to the destination at the current time of day. In some implementations, the platform may perform message classification using trainable classifiers. However, the quality of a classifier may vary due to several factors. For example, the classifier may occasionally be retrained on different or additional training data, and the newly trained classifier may perform worse on actual messages received during operation of the communication services platform. In another example, the words and/or textual patterns used in messages may change over time, and the classifier's parameters may inaccurately handle these new words and/or patterns. In some instances, the degraded classification quality may result in the platform inaccurately classifying messages, which may result in the platform transmitting messages that do not comply with the acceptable use policy and/or applicable laws and regulations and/or the platform preventing the transmission of messages that do comply with the acceptable use policy and/or applicable laws and regulations.

Aspects of the disclosure address the above-mentioned and other challenges by implementing a communication services platform that, in addition to the above-described inline message classifier, employs a quality control classifier to classify at least a subset of incoming messages. The quality control classifier would be designed to yield a better classification quality as compared to the inline classifier, albeit exhibiting worse performance characteristics (e.g., elapsed time to classify a single message). The platform may compare the message categories determined by the inline classifier to the message categories determined by the quality control classifier. The platform may determine the value of a performance metric of the inline classifier (e.g., precision, recall, accuracy, F1 score, etc.) based on these comparisons, and the message category determined by the quality control classifier may be treated as the ground truth when determining the performance metric value. If the performance metric value fails to satisfy a chosen quality criterion, the inline classifier can be modified to increase the quality of its outputs. For example, the platform may modify the inline classifier's parameters, which may include training the inline classifier on training data. The quality control classifier may process each message that the inline classifier processes, or the quality control classifier may process a subset of the messages. For example, the quality control classifier may process a predefined portion of the messages. The subset may include messages randomly selected by the platform. The subset may include messages where a confidence score produced by the line classifier is lower than a threshold score. The confidence score may include a metric output by the inline classifier indicating a confidence that the message category selected by the inline classifier is correct.

As noted above, a technical problem addressed by implementations of the disclosure is efficient, accurate, and automated real-time detection of non-compliant messages that customers provide to the communication services platform for transmission to respective end users. The technical solution to the above-identified technical problem utilizes message categories determined by the inline classifier to determine whether transmitting the messages complies with applicable laws and regulations and/or a platform's acceptable use policy. Thus, a technical effect may include improving the accuracy of determining whether transmitting customer-provided messages is compliant with applicable laws and regulations or an acceptable use policy. Another technical problem addressed by the implementations of the disclosure is the efficient, real-time, automated detection that the performance of the inline classifier has varied beyond a tolerance threshold. The technical solution to the above-identified technical problem utilizes the quality control classifier whose outputs inform the platform as to the quality of the inline classifier's classifications. If the inline classifier's quality has varied beyond a threshold tolerance, the platform can modify the inline classifier's parameters to improve the performance of the inline classifier. Thus, a technical effect may include improving the accuracy of the classifications provided by the inline classifier, which improves the platform's determination regarding whether transmitting customer-provided messages is compliant with applicable laws and regulations or an acceptable use policy.

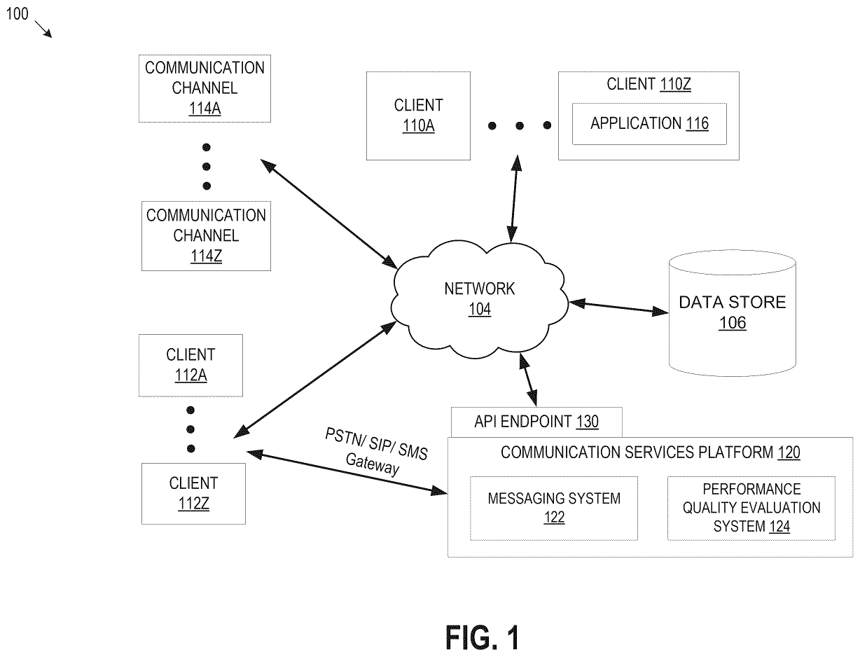

FIG. 1 illustrates an example system architecture 100 for location, consent, and reassigned identifier management for a communication services platform, in accordance with some implementations of the disclosure. The system architecture 100 includes a network 104, a data store 106, one or more client devices 110A-110Z, one or more client devices 112A-112Z, one or more communication channels 114A-114Z, and a communication services platform 120. The client devices 110A-Z, the client devices 112A-112Z, and/or the communication channels 114A-114Z may be communicatively coupled to the platform 120 via the network 104. The data store 106 may be communicatively coupled to the platform 120 via the network.

In some implementations, the network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, the data store 106 is a persistent storage that is capable of storing data as well as data structures to tag, organize, and index the data. The data store 106 may be hosted by one or more storage devices, such as main memory, magnetic or optical storage-based disks, tapes or hard drives, network-attached storage (NAS), storage area network (SAN), and so forth. In some implementations, the data store 106 may be a network-attached file server, while in other implementations, the data store 106 may be other type of persistent storage such as an object-oriented database, a relational database, and so forth, that may be hosted by the communication services platform 120 or one or more different machines coupled to the communication services platform 120 via the network 104. In some implementations, the data store 106 may include a consent record database and/or a location record database. The consent record database may store one or more consent records that include data indicating whether an end user has provided consent for a customer to send messages to the end user. The location record database may store one or more location records that include data indicating the geographic location of an end user. The messaging system 122 (discussed below) may use one or more consent records or location records to determine whether transmitting a message to an end user complies with the platform's 120 acceptable use policy or applicable laws or regulations.

The client devices 110A-Z may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, a client device 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, the client devices 110A-Z may also be referred to as “user devices.”

In some implementations, a client device 110, such as the client device 110Z, can implement or include one or more applications, such as the application 116 executed at the client device 110Z. In some implementations, the application 116 can be used to communicate (e.g., send and receive information) with communication services platform 120. In some implementations, application 116 can implement user interfaces (e.g., graphical user interfaces (GUIs)) that may be webpages rendered by a web browser and displayed on the client device 110Z in a web browser window. In another implementation, the user interfaces of the application 116 may be included in a stand-alone application downloaded to the client device 110Z and natively running on the client device 110Z.

In some implementations, one or more client devices 110 can communicate with the communication services platform 120 using function calls, such as application programming interface (API) function calls. For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing the application 116. In some implementations, the communication services platform 120 can respond to the requests from the client device 110Z by using one or more API responses using an application layer protocol. Similarly, communication services platform 120 can communicate with one or more communication channels 114A-114Z using API function calls.

In some implementations, a communication channel 114 can be implemented by software and/or hardware through which voice calls or messages can be sent to recipient devices (e.g., organizations different from communication services platform 120). In some implementations, the communication services offered by communication channels 114A-114Z can be integrated into the communication services platform 120. In some implementations, the communication services offered by the communication channels 114A-114Z can include voice communication services, messaging services, or other types of communication services. In some implementations, messaging services can include one or more of a SMS implemented by an SMS channel, an MMS offered by an MMS channel, or an IM service (e.g., chat messaging) offered by an IM service channel. In some implementations, communication channels 114A-114Z can also include a voice channel. For example, the voice channel may implement an application to send or receive voice calls. In another example, the voice channel may be implemented by a telecommunication service provider, such as PSTN provider, mobile communication services provider, and/or VoIP services provider.

In some implementations, one or more of client devices 110 can be identified by a uniform resource identifier (URI), such as a uniform resource locator (URL). For example, the communication services platform 120 can send an API call to the client device 110Z addressed to a URL specific to the client device 110Z. In some implementations, the communication services platform 120 can be identified by a URI. For instance, the API call sent by a client device 110 to the communication services platform 120 can be directed to the URL of the communication services platform 120.

In some implementations, a communication endpoint may be a client device of the client devices 112A-Z. A client device 112 may include a device that a user can utilize to communicate with another communication endpoint. A communication endpoint may include a telephony device. A telephony device can include a Public Switched Telephone Network (PSTN) -connected device, such as a cellular phone or messaging-enabled satellite phone. In some implementations, a telephony device can also include an internet addressable voice device (e.g., non-PSTN telephony device), such as messaging-enabled VoIP phones or SIP devices, for example. In some implementations, a telephony device can include one or more messaging devices, such as a SMS network device that, for example, uses a cellular service to exchange SMS messages or MMS messages. A communication endpoint may include other types of devices, such as a landline phone. A communication endpoint can be identified by an identifier (e.g., a phone number, a network address, a universal resource identifier (URL), a numeric identifier, or an alphanumeric string).

In some implementations, the communication services platform 120 may provide communication services that include message transmission services (e.g., transmitting SMS/MMS messages, voice messages, email messages, video messages, and/or Internet-based chat messages. Communication operations using the communication services can use one or more of a communication network (e.g., Internet), telecommunications network (e.g., such as a cellular network, satellite communication network, or landline communication network), or a combination thereof, to transfer communication data between parties.

The communication services platform 120 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, the communication services platform 120 may include a plurality of computing devices that together may comprise a hosted computing resource, a grid computing resource or any other distributed computing arrangement. In some implementations, the communication services platform 120 may correspond to an elastic computing resource where the allotted capacity of processing, network, storage, or other computing-related resources may vary over time.

In an illustrative example, communication services platform 120 can be a Software as a Service (SaaS) platform that can provide communication services to its customers. The SaaS platform may deploy services, such as software applications, to one or more clients for use as an on-demand service. For example, the SaaS platform may deliver and/or license software applications on a subscription basis while also hosting the software application. The licensed software applications can be hosted on the infrastructure, such as the cloud computing resources of the SaaS platform.

In one implementation, an organization can be a customer of the platform 120. An example of an organization may be a legal entity. In some implementations, an organization can be associated with an account (e.g., organizational account) of the communication services platform 120. Within the particular account of the organization, one or more sub-accounts of the communication services platform 120 may be associated with different users of the organization. In some implementations, the accounts are organized in a hierarchical structure where the organizational account is the root at the top of the hierarchy and the user accounts are nested under the organizational account. The communication services platform 120 may include an account management system that manages accounts of the communication services platform 120. Managing accounts may include functionality related to account creation, account deactivation, account suspension, account modification, or other functionality.

In some implementations, the communication services platform 120 can provision identifiers of communication endpoints to an organization's account. Such identifiers may include telephone numbers (e.g., 10-digit long code or short code). The assignment of identifiers can be flexible such that the assignment of an identifier can be one-to-one (e.g., one identifier to one user account) or one to many (e.g., one identifier to many user accounts). Where an account is provided multiple identifiers, the user of the account may be able to dynamically select which identifier to use, for example, as the sender identifier when the platform 120 forwards a message to a recipient end user.

In some implementations, the communication services platform 120 further includes a messaging system 122. The messaging system 122 may include hardware and/or software that functions to interface with one or more communication networks and/or services for facilitating SMS, MMS, IM, and/or other carrier-based messages. The messaging system 122 may receive a message transmission request from a customer of the platform 120. The messaging system 122 may receive the message transmission request from a client device 110 used by a customer. The messaging system 122 may cause the platform 120 to forward one or more messages based on the message transmission request. A message transmission request can include a data object characterizing the properties of a message. In some implementations, the messaging system 122 is associated with message transmission requests that are programmatically initiated (e.g., an application-to-person (A2P) message).

In some implementations, a message transmission request can include an origin endpoint. The origin endpoint may include a communication endpoint identifier included in the message transmission request or may be specified indirectly such as through a system or account configuration or identifier (e.g., messaging conversation identifier). For example, a message may be automatically assigned an origin endpoint that is associated with an account of the customer that provided the message transmission request, as indicated by an account configuration of the customer's account. A message transmission request may include one or more destination endpoints, which may include one or more communication endpoint identifiers associated with the recipient end user(s) of the message. In some implementations, the message transmission request can include a message payload, which can include any suitable type of media content including, text, audio, image data, video data, multimedia, interactive media, data, and/or any suitable type of content that can be included in a message payload.

In some implementations, the messaging system 122 may determine whether transmitting a given message would comply with an acceptable use policy of the communication services platform 120 or with applicable laws or regulations. For example, applicable law may prevent sending messages related to certain message categories during a certain time range (e.g., sending marketing messages between 8 p.m. and 8 a.m.). If the messaging system 122 determines that sending the message would comply with the acceptable use policy and/or applicable laws and regulations, the messaging system 122 may proceed to forward the message to its destination. However, if sending the message would not comply with the acceptable use policy and/or applicable laws and regulations, the messaging system 122 may drop the message or reschedule the message to be transmitted at a later time (e.g., at a time when sending the message would comply, as discussed further below).

In one implementation, the messaging system 122 may use an inline classifier to determine the message category of the message. The inline classifier may determine the message category of the message based on the message payload (i.e., the content of the body of the message). The messaging system 122 may use a location record storage of the data store 106 to determine a location associated with the recipient communication endpoint identifier and to determine a current time associated with the location.

In some implementations, the communication services platform 120 further includes a performance quality evaluation system 124. The performance quality evaluation system 124 may include hardware and/or software that evaluates the performance of the inline classifier used by the messaging system 122 to classify messages into message categories. In one implementation, the performance quality evaluation system 124 may evaluate the performance of the inline classifier by determining a value of a performance metric of the inline classifier. The performance metric may be, e.g., an F1 score for the inline classifier, a precision of the inline classifier, a recall of the inline classifier, or another metric indicative of the quality of the inline classifier. The performance quality evaluation system 124 may determine the value of the performance metric of the inline classifier by using a quality control classifier to classify messages into message categories and comparing the outputs of the inline classifier to the outputs of the quality control classifier. If the performance quality evaluation system 124 determines that the performance of the inline classifier does not satisfy a quality condition, the performance quality evaluation system 124 may cause the platform 120 to perform a corrective action regarding the inline classifier.

In some implementations, a corrective action regarding the inline classifier may include modifying one or more parameters of the inline classifier. Modifying parameters may include retraining the inline classifier on training data that is different from, or in addition to, the training dataset originally used to train the inline classifier. Modifying the parameters of the inline classifier may include adjusting hyperparameters of the inline classifier (e.g., where the inline classifier is an artificial neural network (ANN), modifying the number of hidden layers, modifying how some of the synapses connect to neurons, modifying the number of neurons in a layer, etc.). A corrective action may include other processes that improve the inline classifier performance.

Returning to the communication services platform 120, in some implementations, the communication services platform 120 further provides one or more API endpoints 130 that can expose services, functionality or content of the communication services platform 120 to one or more of client devices 110 or communication channels 114A-114Z. In some implementations, an API endpoint 130 can be an endpoint of a communication channel in which the other endpoint can be implemented by another system, such as the client device 110Z or communication channel 114Z. In some implementations, the API endpoint 130 can include or be accessed using a resource locator, such a universal resource locator (URL), of a server or service. The API endpoint 130 can receive requests from other systems, and in some cases, return a response with information responsive to the request. In some implementations, HTTP or HTTPS methods can be used to communicate to and from API endpoint 130.

In some implementations, the API endpoint 130 can function as a computer interface through which communication requests, such as message and/or voice requests, are received and/or created. The communication services platform 120 may include one or more types of API endpoints.

In some implementations, the API endpoint 130 can include a messaging API. External entities or systems can use the messaging API to send, to the communication services platform 120, a communication to create message content and/or request sending of a message. The messaging API may be used in programmatically creating message content and/or requesting sending of one or more messages. In some implementations, the messaging API is implemented in connection with a multitenant communication service wherein different accounts (e.g., authenticated entities) can submit independent requests. These requests made through the messaging API can be managed with consideration of other requests made within an account and/or across multiple accounts on the communication service.

In some implementations, the messaging API may be used in initiating general messaging or communication requests. For example, a messaging request may indicate one or more destination endpoints (e.g., as identified by recipient phone numbers), message content (e.g., text and/or media content), and possibly an origin endpoint (e.g., as identified by a phone number to use as the “sending” phone number).

In some implementations, the messaging API may be any suitable type of API such as a Representational State Transfer (REST) API, a GraphQL API, a Simple Object Access Protocol (SOAP) API, and/or any suitable type of API. In some implementations, the communication services platform 120 can expose through the API, a set of API resources which when addressed may be used for requesting different actions, inspecting state or data, and/or otherwise interacting with the communication platform. In some implementations, a REST API and/or another type of API may work according to an application layer request and response model. An application layer request and response model may use HTTP, Hypertext Transfer Protocol Secure (HTTPS), SPDY, or any suitable application layer protocol. Herein, HTTP-based protocol is described for purposes of illustration, the application layer may use other protocols. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE. In some implementations, the API endpoint 130 can include a console, administrator interface, or other suitable type of user interface. Such a user-facing interface can be a graphical user interface. Such a user interface may additionally work in connection with a programmatic interface.

In some implementations, one or more APIs that the application 116 executing on a desktop client device (e.g., a desktop application) uses to access the messaging system 122 can be different APIs than the APIs used by the application 116 executed on a mobile client device (e.g., mobile application) to access the messaging system 122. In one implementation, the APIs used to communicate between the messaging system 122 and other systems of the communication services platform 120 may be private APIs that are not accessible by client devices 110 (or client devices 112).

Although implementations of the disclosure are discussed in terms of communication service platforms, implementations may also be generally applied to any type of platform, system or service. Furthermore, in general, functions described in some implementations as being performed by the communication services platform 120 can also be performed on the client devices 110A-110Z in other implementations (and vice versa), if appropriate. In addition, the functionality attributed to a particular component can be performed by different or multiple components operating together. The communication services platform 120 can also be accessed as a service provided to other systems or devices through appropriate APIs.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the communication services platform 120.

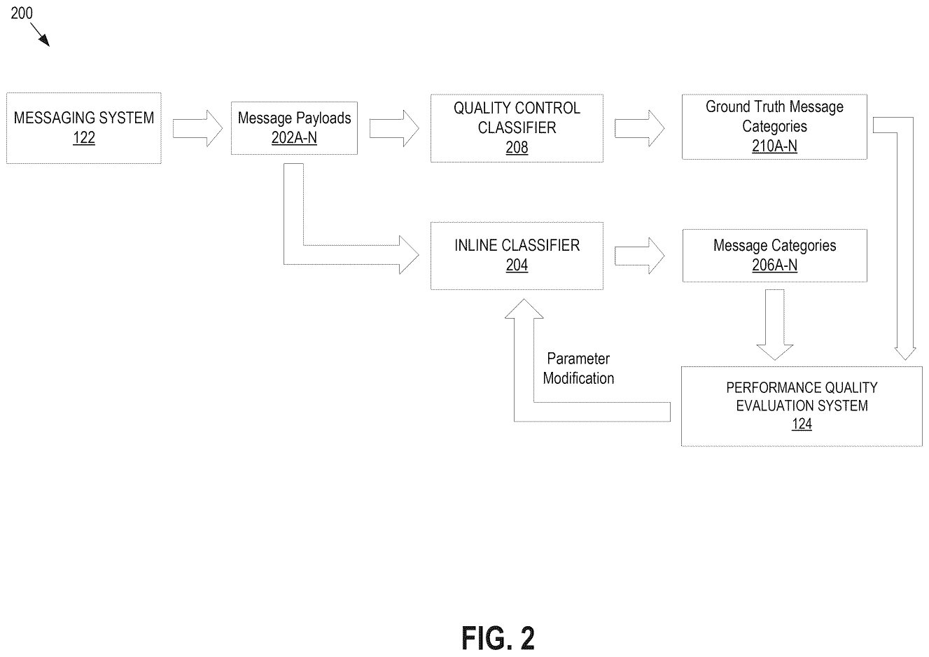

FIG. 2 illustrates an example flow of data 200 for real-time classification quality evaluation for a communication services platform 120, in accordance with some implementations of the disclosure. Some components of FIG. 1 are used to help describe aspects of FIG. 2. For example, the data flow 200 depicts the messaging system 122 and the performance quality evaluation system 124 of FIG. 1.

In one implementation, customers of the communication services platform 120 may submit messaging transmission requests using the respective applications 116, and the platform 120 may receive the messaging transmission requests via an API endpoint 130. The message transmission requests may include requests from customers of the platform 120 to forward (e.g., communication channels 114A-Z) the messages to respective recipient communication endpoints identified by respective recipient communication endpoint identifiers. In some implementations, each message of the message transmission requests may include a message payload (e.g., text data, image data, video data, etc.). The platform 120 may provide the message transmission requests to the messaging system 122. The messaging system 122 may process each message of the message transmission requests to determine, based on the payload of the message, whether transmitting the message complies with an acceptable use policy of the platform 120 and/or complies with applicable laws and regulations.

In some implementations, the messaging system 122 may determine whether a message category associated with a message to be transmitted is subject to a time-of-day restriction. A time-of-day restriction may include a restriction on sending messages of a predetermined message category within a predetermined time-of-day range. For example, a time-of-day restriction may include a restriction on sending marketing, political, educational, religious, or charitable messages between the hours of 9 p.m. and 8 a.m. of the local time of the location of the message recipient. In some implementations, determining the message category associated with a message may include the messaging system 122 providing the message payload 202A of a message to an inline classifier 204 and using the inline classifier 204 to generate an output based on the message payload 202A of the message. The output may include the message category 206A associated with the message. The messaging system 122 may use the message category 206A to determine whether the message is subject to a time-of-day restriction. Messages associated with certain message categories may be subject to a time-of-day restriction while messages associated with other message categories may not.

In some implementations, messages not subject to a time-of-day restriction can include verification, transactional, announcement, customer support, security, or healthcare messages. Messages subject to a time-of data restriction can include conversational, marketing, political, educational, charitable, or religious messages. In one implementation, a message category may be a verification category. A verification message may include a message associated with verifying an identity of a recipient user associated with a customer that sent the message. Examples of verification messages include messages that include one-time passwords (OTPs), multi-factor authentication (MFA) verification codes, or other data used to verify that a user has requested an action. A message category may be a transactional category. A transactional message may include a message associated with providing transactional information to the customer that sent the message to the user. A transactional message may include a message that includes a product or service order confirmation, a delivery notification, a user account notification (e.g., a notification that the user's account has been created, changed, or suspended), or other data associated with a transaction associated with the user receiving the message.

A message category may be a marketing category. A marketing message may include a message associated with providing marketing information to the user. A marketing message may include a message notifying the user about promotions, discounts, events, offers, product or service announcements, or rewards programs. A message may be an announcements category. An announcement message may include a message associated with notifying a user about emergency alerts, traffic conditions, service disruptions, public safety campaigns, or other similar events. A message category may be a customer support category. A customer support message may include a message associated with notifying a user about customer-related issues, including updates to services or products the user has purchased, issue resolution notifications, customer service availability notifications, order confirmations, or the like.

A message category may be a security/emergency message category. A security/emergency message may include a message notifying the user about security-or emergency-related information. A security/emergency message may include a message associated with the security of an account of the user. For example, a security/emergency message may notify the user about a data breach, a password change or reset, a suspicious transaction, scams, or other security-related information. A security/emergency message may include a message notifying a user about natural disasters, evacuations, public health emergencies, safety warnings, or other emergency-related information. A message category may be a healthcare category. A healthcare message may include a message notifying the user about healthcare-related information. A healthcare message may include a message notifying the user about a healthcare appointment, a vaccine reminder, medical test results, public health alerts, or other healthcare-related information. Other message categories may include categories related to charitable, religious, educational, or political topics, or general conversation.

In one implementation, as discussed above, the messaging system 122 may use the inline classifier 204 to determine a corresponding message category 206A-N for each message processed by the messaging system 122. The inline classifier 204 may include an AI model trained to use the message payloads 202A-N as input and perform inference calculations to determine the message categories 206A-N associated with the respective input payloads 202A-N. The messaging system 122 may determine, for a certain message, the message category 206 associated with the message is subject to a time-of-day restriction. In response, the messaging system 122 may determine whether transmitting the message at the current time complies with the time-of-day restriction. If transmitting the message at the current time complies with the time-of-day restriction, the messaging system 122 may cause the message to be transmitted to the communication endpoint identified by the message's recipient communication endpoint identifier. However, if sending the message at the current time does not comply with the time-of-day restriction, the messaging system 122 may schedule the message to be transmitted to the recipient communication endpoint at a time at which sending the message would comply with the time-of-day restriction. The rescheduled time may be the next time that sending the message complies with the time-of-day restriction, a time when the number of messages waiting to be transmitted by the messaging system 122 is below a threshold number of messages (which may indicate that the rescheduled time is not a peak messaging time), a time when transmitting all rescheduled can be performed uniformly over a subsequent time range where sending the messages would comply with the time-of-day restriction, or a time selected at random by the messaging system 122.

In some implementations, the quality of the classification of the message categories 206A-N determined by the inline classifier, as indicated by pertinent performance metrics (such as recall, precision, or F1 score) may degrade. For example, the words used in the message payloads 202A-N, the arrangement of words in the message payloads 202A-N, or other data of the message payloads 202A-N may have changed since the time the inline classifier 204 was trained. This may result in a substantial number of message categories 206A-N determined by the inline classifier 204 to be inaccurate. In another example, the inline classifier 204 may undergo a training process on a training dataset (which may be in addition to the training process initially performed on the inline classifier 204), and the training process may degrade the performance of the inline classifier 204 (e.g., due to the poor quality of the training dataset). To detect the degradation of the inline classifier 204, the performance quality evaluation system 124 may use the quality control classifier 208.

In one implementation, the quality control classifier 208 may determine ground truth message categories 210A-N associated with at least a subset of the message payloads 202A-N processed by the inline classifier 204. Similar to the inline classifier 204, the quality control classifier 208 may receive one or more message payloads 202A-N as input and may perform inference calculations on the input message payloads 202A-N to determine the respective ground truth message categories 210A-N associated with the input message payloads 202A-N.

In one implementation, the inline classifier 204 or the quality control classifier 208 may include one or more of artificial neural networks (ANNs), decision trees, random forests, support vector machines (SVMs), clustering-based models, Bayesian networks, or other types of AI models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network. ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In some implementations, the inline classifier 204 or the quality control classifier 208 may include a generative AI model. A generative AI model may be trained and/or configured to generate new and original content. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks. The generative AI model can use other machine learning models including an encoder-decoder architecture including one or more self-attention mechanisms, and one or more feed-forward mechanisms. In some implementations, the generative AI model includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including RNNs, CNNs, or transformer networks.

In some implementations, the inline classifier 204 and the quality control classifier 208 may have different capabilities, configurations, or features. For example, an average time of the inline classifier 204 processing a message of the one or more messages (e.g., by performing inference calculations on the message payloads 202A-N) may be less than an average time of the quality control classifier 208 processing a message of the one or more messages. In one implementation, the inline classifier 204 may be faster because the inline classifier 204 may be, relative to the quality control classifier 208, a lightweight AI model, and the quality control classifier 208 may be larger than the inline classifier 204 (e.g., where the quality control classifier 208 is an ANN, the quality control classifier 208 may have more neurons, synapses, hidden layers, etc.). In some implementations, the quality control classifier 208 may have a higher precision than the inline classifier 204. Because of the speed or computational resources used by the quality control classifier 208, the messaging system 122 may not use the quality control classifier 208 in real time to determine message categories.

In some implementations, the quality control classifier 208 may process each message payload 202A-N that the inline classifier 204 processes. In one implementation, the quality control classifier 208 may process a subset of the message payloads 202A-N that the inline classifier 204 processes. The messaging system 122 may randomly select message payloads 202A-N for the quality control classifier 208 to process.

In one implementation, the performance quality evaluation system 124 may compare message categories 206A-N and ground truth message categories 210A-N for the same message payloads 202A-N. For example, the performance quality evaluation system 124 may compare the message category 206A to the ground truth message category 210A (which were both determined from the message payload 202A), the performance quality evaluation system 124 may compare the message category 206B to the ground truth message category 210B (which were both determined from the message payload 202B), the performance quality evaluation system 124 may compare the message category 206C to the ground truth message category 210C (which were both determined from the message payload 202C), and so on. The comparisons may indicate whether the inline classifier 204 correctly determined the message categories 206A-N. The ground truth message categories 210A-N determined by the quality control classifier 208 may be used as the ground truths of the comparisons. The performance quality evaluation system 124 may compare the message categories 206A-N and the ground truthy message categories 210A-N to determine a value of a performance metric of the inline classifier 204.

In some implementations, the performance metric may be a precision of the inline classifier 204. The precision may measure the proportion of message categories 206A-N that were actually correct (using the corresponding ground truth message categories 210A-N as the correct value). In one implementation, the performance metric may be a recall of the inline classifier 204. The recall may measure the proportion of determinations of a certain message category that were correctly identified. For example, a recall for the verification message category may be calculated by dividing the number of message payloads 202A-N that the inline classifier 204 correctly determined are verification messages by the total number of payloads 202A-N that actually belong to the verification message category (as determined by the quality control classifier 208). The performance quality evaluation system 124 may calculate the recall for each message category and may use the multiple recall values to calculate a mean recall value, which the performance quality evaluation system 124 may use as the recall value for the inline classifier 204. In one implementation, the performance metric may be an F1 score for the inline classifier 204. The F1 score may be the harmonic mean of precision and recall for the inline classifier 204, which may be calculated as F1 Score=2*(Precision*Recall)/(Precision +Recall).

In one implementation, the performance quality evaluation system 124 may determine that the value of the performance metric does not satisfy a predetermined quality condition. The predetermined quality condition may include a threshold value for the performance metric. For example, where the performance metric is a recall of the inline classifier 204, the threshold recall value may be 0.9. If the recall of the inline classifier 204 is below 0.9, the performance quality evaluation system 124 may cause a modification to one or more parameters of the inline classifier 204. If the recall is at or above the threshold recall value, the messaging system 122 may continue to use the inline classifier 204 without modifying the inline classifier's 204 parameters.

In some implementations, modifying the parameters of the inline classifier 204 may include modifying a hyperparameter of the inline classifier 204. A hyperparameter may include a parameter of the inline classifier 204 that is not adjusted during training. Examples of hyperparameters include learning rate, number of epochs, or other parameters. Where the inline classifier 204 is an ANN, a hyperparameter may be the number of hidden layers, the arrangement the synapses, the number of neurons in a layer, etc. In one implementation, modifying the parameters of the inline classifier 204 may include fine-tuning the inline classifier 204 on additional training data. In some implementations, modifying the parameters may include retraining the inline classifier 204 on a training dataset.

In one implementation, the performance quality evaluation system 124 may determine whether a message payload metric of the message payloads 202A-N or a subset thereof (e.g., message payload length, word usage metrics, textual pattern metrics, etc., as discussed below) satisfy a payload condition. A message payload metric not satisfying the corresponding payload condition may indicate that the inline classifier 204 should be retrained. The message payload metric may reflect (i.e., be derived by applying a predefined mathematical transformation to) the message payload length (e.g., a number of text characters in a message payload 202), out-of-vocabulary words ratio, non-letter character ratio (e.g., the ratio of text characters that are not letters to text characters that are letters), and/or a word usage metric reflective of a frequency of occurrence of a certain word in messages associated with a certain message category. The out-of-vocabulary words ratio may include a ratio of (1) the number of words in a message payload 202 that are not present in message payloads used to train the inline classifier 204, to (2) the words in the message payload 202 that are present in message payloads used to train the inline classifier 204.

In one implementation, the payload condition for message payload length may be the average message payload length for a sample of message payloads (as explained below) being less than a message payload length threshold. The message payload length threshold may be, e.g., the message payload length of the longest message payload used to train the inline classifier 204, or a value provided by configuration data of the performance quality evaluation system 124 (e.g., a value input by an administrator of the platform 120). In some implementations, the payload condition for out-of-vocabulary words ratio may be the average out-of-vocabulary words ratio for the sample of message payloads being more than a threshold value. The threshold value may include a value provided by configuration data of the performance quality evaluation system 124. In one implementation, the payload condition for non-letter character ratio may be the average non-letter character ratio for the sample of message payloads being less than a threshold value. The threshold value may be the highest non-letter character ratio for a message payload used to train the inline classifier 204 or a value provided by configuration data of the performance quality evaluation system 124. In some implementations, the payload condition for the word usage metric for a certain word may be the average usage of the word in the sample of message payloads being less than a threshold value. The threshold value may include include the highest frequency of occurrence of that word in the payload messages used to train the inline classifier or a value provided by configuration data of the performance quality evaluation system 124.

As discussed above, the performance quality evaluation system 124 may select a sample of message payloads from the message payloads 202A-N for which a message payload metric value may be calculated to determine if the calculated value satisfies a corresponding payload condition. The sample may include at least a predefined number of randomly selected message payloads 202A-N. The performance quality evaluation system 124 may determine the value of the message payload metric for the sample. For example, where the message payload metric is the message payload length, the performance quality evaluation system 124 may determine the message payload length for each message payload in the sample. Where the message payload metric is the word usage metric, the performance quality evaluation system 124 may determine the frequency of the occurrence of a certain word in each message payload of the sample. The performance quality evaluation system 124 may use the determined message payload metrics for the individual message payloads of the sample to calculate an average message payload metric value for the sample.

The performance quality evaluation system 124 may determine whether the value of the message payload metric for the sample satisfies a payload condition, as discussed above. In one implementation, if the performance quality evaluation system 124 determines that the value of the message payload metric for the sample does not satisfy the payload condition, the performance quality evaluation system 124 may modify one or more parameters of the inline classifier 204, e.g., by retraining the inline classifier 204 on a training dataset. The training dataset may include message payloads that have been received by the platform 120 more recently than message payloads previously used to train the inline classifier 204. Using more recently received message payloads to train the inline classifier 204 may assist the inline classifier 204 to generate outputs are reflective message payloads that have undergone data drift. In some implementations, each item of the training dataset may include a certain message category as a target output label, which may have been determined by the quality control classifier 208. For example, where the message payload metric is a word usage metric reflective of a frequency of the occurrence of a certain word used in messages, the threshold word usage metric value associated with the word usage metric condition may have been determined for messages of a certain message category (e.g., marketing messages). The training dataset may include items of training data that use the marketing message category as their target output labels.

In some implementations, the performance quality evaluation system 124 may determine whether message payloads 202A-N have undergone data drift by using a drift detection AI model, which may be trained to determine whether an input message payload originated from a first, older set of messages, or whether the input message payload originated from a second, more recent set of messages (e.g., the message payloads 202A-N). If the drift detection AI model can determine whether an input message belongs to the first set of messages or to the second set of messages at or above a threshold accuracy, that may indicate the message payloads 202A-N have undergone data drift and that the inline classifier 204 should be retrained. However, inability of the drift detection AI model to accurately distinguish messages from the older set of messages from the more recent messages may indicate no significant drift in the message payloads 202A-N, in which case the inline classifier 204 does not need to be retrained.

In one implementation, the drift detection AI model may be trained on a training dataset. Each item of the training dataset may include a message payload and a corresponding target output label indicating whether the respective message payload originated from an older set of messages or originated from a more recent set of messages. In some implementations, the older set of messages may include messages included in a training dataset used to previously train the inline classifier 204.

In some implementations, the performance quality evaluation system 124 may obtain a current set of message payloads. The current set may include a portion of the message payloads 202A-N (e.g., the performance quality evaluation system 124 may randomly select a predetermined number of the message payloads 202A-N). The performance quality evaluation system 124 may obtain a historical set of message payloads. The historical set may include one or more message payloads included in a training dataset previously used to train the inline classifier 204. For example, the historical set may include message payloads from the training dataset that was most recently used to train the inline classifier 204. The performance quality evaluation system 124 may randomly select a predetermined number of the message payloads from that training dataset. The historical set may not include message payloads included in the training dataset used to train the drift detection AI model. The performance quality evaluation system 124 may use the historical set and the current set as input to the drift detection AI model, and the drift detection AI model may determine, for each input message, whether the respective message is associated with the historical set of messages or is associated with the current set of messages.

In some implementations, the performance quality evaluation system 124 may determine a value of a performance metric of the drift detection AI model. The performance metric may indicate a performance quality of the drift detection AI model in correctly determining whether input message payloads belong to the historical set of messages or to the current set of messages. For example, the performance quality evaluation system 124 may perform a two-sample test or a chi-squared test using the outputs of the drift detection AI model to determine if drift detection AI model's performance differs from random chance. A two-sample test or chi-squared test may include performing a statistical analysis on the outputs of the drift detection AI model to calculate a p-value and select a significance level. The p-value may be the probability of the drift detection AI model making the number of correct determinations during the statistical analysis at random. If the p-value is less than the significance level, then the performance quality evaluation system 124 determines that the performance metric does not satisfy the predefined quality condition. In another example, the performance metric may include a recall, precision, or F1 score for the drift detection AI model. The recall may measure the proportion of determinations made by the drift detection AI model that were correctly identified. The precision may measure the proportion of determinations made by the drift detection AI model that were actually correct. The F1 score may be the harmonic mean of precision and recall for the drift detection AI model, which may be calculated as F1 Score=2*(Precision*Recall)/ (Precision+Recall).

If the value of the performance metric does not satisfy a predefined quality condition, the performance quality evaluation system 124 may modify the parameters of the inline classifier 204. The predetermined quality condition may include the performance metric value indicating that the drift detection AI model's performance differs from random chance and, thus, there is a substantial difference between historical messages and a current set of messages. For example, if the performance metric is a recall, precision, or F1 score, then a recall, precision or F1 score above 0.5 may indicate that the drift detection AI model's performance differs from random chance.

In one implementation, the communication services platform 120 may cause a client device 110 to display a dashboard user interface (UI). The dashboard UI may present the value of the performance metric of the inline classifier 204 and a threshold value for the performance metric associated with the predefined quality condition for the inline classifier 204. The dashboard UI may present the value of the performance metric of the drift detection AI model and the threshold value for the performance metric associated with the predefined quality condition for the drift detection AI model. The dashboard UI may present threshold values associated with a message payload metric and the value of the message payload metric for the sample of message payloads 202A-N. The presented data may be associated with a predefined time range (e.g., the previous 24 hours, the previous week, the previous month, etc.). By presenting such data, the dashboard UI may provide a visual representation of the performance quality of the inline classifier 204 or a visual representation of data drift undergone by the message payloads 202A-N.

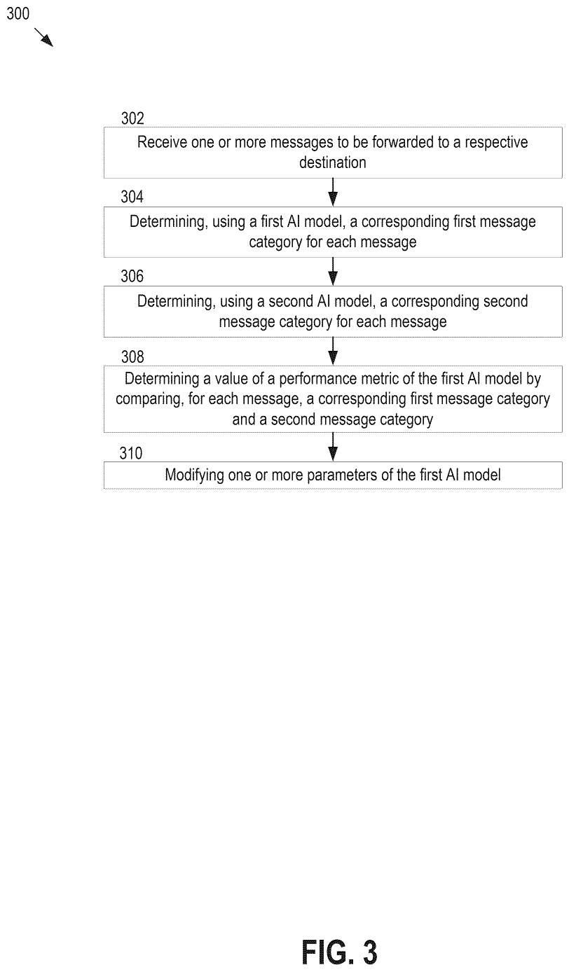

FIG. 3 depicts a flow diagram of an example method 300 for real-time classification quality evaluation for a communication services platform 120, in accordance with some implementations of the disclosure. In some implementations, the method 300 can be performed by the communication services platform 120, and in particular, by the messaging system 122 or the performance quality evaluation system 124.

The method 300 of FIG. 3 and/or each of the method's 300 individual functions, routines, subroutines, or operations can be performed by a processing device, having one or more processing units (CPU) and memory devices communicatively coupled to the CPU(s). In some implementations, the method 300 can be performed by a single processing thread or alternatively by two or more processing threads, each thread executing one or more individual functions, routines, subroutines, or operations of the method. The method 300, as described below, can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the operations of the method 300 can be modified. Thus, the illustrated implementations should be understood only as examples, and the illustrated operations can be performed in a different order, while some operations can be performed in parallel. Additionally, one or more operations can be omitted. In some implementations. Thus, not all illustrated operations are required in every implementation, and other process flows are possible. In some implementations, the same, different, fewer, or greater operations can be performed. It may be noted that elements of FIG. 1-2 may be used herein to help describe FIG. 3.

At operation 302, processing logic receives, by the communication services platform 120, one or more first messages to be transmitted to respective destinations. The one or more first messages may include the one or more message payloads 202A-n of FIG. 2. The messaging system 122 may receive the one or more first messages.

At operation 304, processing logic determines, using a first AI model, a corresponding first message category for each message of the one or more first messages. The first AI model may be the inline classifier 204. The corresponding message category for each message may be a message category 206 determined by the inline classifier 204 by using the message payload 202 for the respective message as input, as discussed above in relation to FIG. 2.

At operation 306, processing logic determines, using a second AI model, a corresponding second message category for each message of the one or more first messages. The second AI model may be the quality control classifier 208. The corresponding second message category may be a ground truth message category 210 determined by the quality control classifier 208 by using the message payload 202 for the respective message as input, as discussed above in relation to FIG. 2.

At operation 308, processing logic determines a value of a performance metric of the first AI model by comparing, for each message, a corresponding first message category 206 and a second message category 210. As discussed above in relation to FIG. 2, the performance quality evaluation system 124 may compare message categories 206A-N and ground truth message categories 210A-N for the same message payloads 202A-N. The comparisons may indicate whether the inline classifier 204 correctly determined the message categories 206A-N. The ground truth message categories 210A-N determined by the quality control classifier 208 may be used as the ground truths of the comparisons. The performance metric may be a precision of the inline classifier 204, a recall of the inline classifier 204, or an F1 score for the inline classifier 204.

At operation 310, if the performance quality evaluation system 124 determines that the value of the performance metric does not satisfy a predefined quality condition, processing logic modifies one or more parameters of the first AI model. Modifying one or more parameters of the first AI model may improve the performance of the first AI model and may result in an improvement to a value of a future performance metric determined for the first AI model. Modifying parameters of the inline classifier 204 may include adjusting hyperparameters of the inline classifier 204 or retraining the inline classifier 204, as discussed above. Processing logic may delay the transmitting of at least one message of the one or more first messages, for example, until the inline classifier's 204 parameters have been modified and the message can be re-input into the modified inline classifier 204 to determine the message category associated with the message.

The method 300 may further include determining a data drift of the one or more first messages. For example, as discussed above in relation to FIG. 2, processing logic may determine whether a message payload metric of the message payloads 202A-N (e.g., message payload length, word usage metrics, textual pattern metrics, etc., as discussed below) satisfy a payload condition. The message payload metric may reflect (i.e., be derived by applying a predefined mathematical transformation to) the message payload length, out-of-vocabulary words ratio, non-letter character ratio, and/or a word usage metric reflective of a frequency of occurrence of a certain word in messages associated with a certain message category.

Processing logic may select a sample of the one or more message payloads 202A-N). Processing logic may determine a value of the message payload metric for the sample and determine whether the value of the message payload metric for the sample satisfies a payload condition. If the value of the message payload metric for the sample does not satisfy the payload condition, processing logic may modify parameters of the inline classifier 204. In another example, the performance quality evaluation system 124 may use a drift detection AI model to determine if the message payloads 202A-N have experienced data draft, and if so, the performance quality evaluation system 124 may modify parameters of the inline classifier 204.

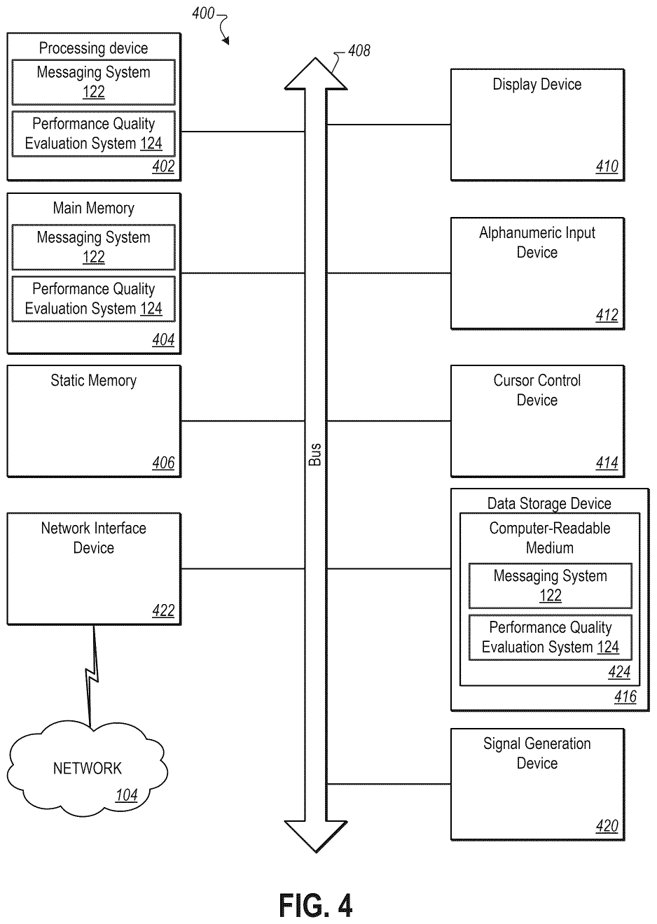

FIG. 4 is a block diagram illustrating an exemplary computer system 400, in accordance with an implementation of the disclosure. The computer system 400 executes one or more sets of instructions that cause the machine to perform any one or more of the methodologies discussed herein. Set of instructions, instructions, and the like may refer to instructions that, when executed by the computer system 400, cause the computer system 400 to perform one or more operations of the messaging system 122 and/or the performance quality evaluation system 124. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 416, which communicate with each other via a bus 408.

The processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute instructions of the system architecture 100, the messaging system 122, and/or the performance quality evaluation system 124.

The computer system 400 may further include a network interface device 422 that provides communication with other machines over the network 104, such as a local area network (LAN), an intranet, an extranet, or the Internet. The computer system 400 also may include a display device 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a non-transitory computer-readable storage medium 424 on which is stored the sets of instructions of the system architecture 100, the messaging system 122, and/or the performance quality evaluation system 124embodying any one or more of the methodologies or functions described herein. The sets of instructions of the system architecture 100, the messaging system 122, and/or the performance quality evaluation system 124 may also reside, completely or at least partially, within the main memory 404 and/or within the processing device 402 during execution thereof by the computer system 400, the main memory 404 and the processing device 402 also constituting computer-readable storage media. The sets of instructions may further be transmitted or received over the network 418 via the network interface device 422.

While the example of the computer-readable storage medium 424 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “obtaining,” “determining,” “performing,” “suspending,” “disabling,” “providing,” “calculating,” “sending,” “receiving,” “notifying” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, by a communication services platform, a first plurality of messages to be transmitted to respective destinations;
determining, using a first artificial intelligence (AI) model, a corresponding first message category for each message of the first plurality of messages;
determining, using a second AI model, a corresponding second message category for each message of the first plurality of messages;
determining a value of a performance metric of the first AI model by comparing, for each message, the corresponding first message category and the second message category; and
responsive to determining that the value of the performance metric does not satisfy a predefined quality condition, modifying one or more parameters of the first AI model to improve a value of a performance metric of the first AI model.

2. The method of claim 1, wherein an average time of the first AI model processing a message of the first plurality of messages is less than an average time of the second AI model processing a message of the first plurality of messages.

3. The method of claim 1, wherein the second AI model has a higher precision that the first AI model.

4. The method of claim 1, wherein the performance metric comprises at least one of:
an F1 score for the first AI model;
a precision of the first AI model; or
a recall of the first AI model.

5. The method of claim 1, wherein the first message category is one of:
a verification category, wherein a message associated with the verification category is sent for verifying an identity of a recipient user;
a transactional category, wherein a message associated with the transactional category includes a message for providing transactional information to the recipient user;
a security category, wherein a message associated with the security category includes a message associated with the security of an account that is associated with the recipient user; or
marketing category, wherein a message associated with the marketing category includes a message for providing marketing information to the recipient user.

6. The method of claim 1, further comprising:
determining a baseline value of a message payload metric reflective of a feature of message payloads of a second plurality of messages;
selecting a sample of the first plurality of messages, wherein the sample comprises one or more messages of the first plurality of messages;
determining a value of the message payload metric for the sample;
determining whether the baseline value of the message payload metric and the value of the message payload metric for the sample satisfy a predefined similarity condition; and
responsive determining that the baseline value of the message payload metric and the value of the message payload metric for the sample do not satisfy the predefined similarity condition, further modifying the one or more parameters of the first AI model.

7. The method of claim 6, wherein the message payload metric is at least one of:
a message payload length reflective of a length of a message of the second plurality of messages;
an out-of-vocabulary ratio reflective of a ratio of a number of words not found in the second plurality of messages to a number of words found in the second plurality of messages;
a non-letter character ratio reflective of a ratio of text characters that are not letters to text characters that are letters; or
a word usage metric reflective of a frequency of an occurrence of a first word in used in the second plurality of messages.

8. The method of claim 1, further comprising:
obtaining a third plurality of messages comprising a portion of the first plurality of messages and a portion of a second plurality of messages, wherein the second plurality of messages were included in a training dataset used to train the first AI model;
determining, using a third AI model, for each message in a subset of the third plurality of messages, whether the respective message is associated with the first plurality of messages or the second plurality of messages;
determining a value of a performance metric of the third AI model; and
responsive to determining that the value of the performance metric of the third AI model does not satisfy a predefined quality condition, further modifying one or more parameters of the first AI model.

9. A system, comprising:
a processing device; and
a memory, coupled with the processing device, configured to perform operations comprising:
receiving, by a communication services platform, a first plurality of messages to be transmitted to respective destinations,
determining, using a first artificial intelligence (AI) model, a corresponding first message category for each message of the first plurality of messages,
determining, using a second AI model, a corresponding second message category for each message of the first plurality of messages,
determining a value of a performance metric of the first AI model by comparing, for each message, the corresponding first message category and the second message category, and
responsive to determining that the value of the performance metric does not satisfy a predefined quality condition, modifying one or more parameters of the first AI model to improve a value of a performance metric of the first AI model.

10. The system of claim 9, wherein an average time of the first AI model processing a message of first plurality of messages is less than an average time of the second AI model processing a message of the first plurality of messages.

11. The system of claim 9, wherein the second AI model has a higher precision that the first AI model.

12. The system of claim 9, wherein the performance metric comprises at least one of:
an F1 score for the first AI model;
a precision of the first AI model; or
a recall of the first AI model.

13. The system of claim 9, wherein the first message category is one of:
a verification category, wherein a message associated with the verification category is sent for verifying an identity of a recipient user;
a transactional category, wherein a message associated with the transactional category includes a message for providing transactional information to the recipient user;
a security category, wherein a message associated with the security category includes a message associated with the security of an account that is associated with the recipient user; or
marketing category, wherein a message associated with the marketing category includes a message for providing marketing information to the recipient user.

14. The system of claim 9, wherein the operations further comprise:
responsive to determining that the value of the performance metric does not satisfy the predefined quality condition, delaying a transmitting of at least one message of the first plurality of messages.

15. A non-transitory computer-readable storage medium including instructions that, when executed by a processing device, cause the processing device to perform operations comprising:
receiving, by a communication services platform, a first plurality of messages to be transmitted to respective destinations;
determining, using a first artificial intelligence (AI) model, a corresponding first message category for each message of the first plurality of messages;
determining, using a second AI model, a corresponding second message category for each message of the first plurality of messages;
determining a value of a performance metric of the first AI model by comparing, for each message, the corresponding first message category and the second message category; and
responsive to determining that the value of the performance metric does not satisfy a predefined quality condition, modifying one or more parameters of the first AI model to improve a value of a performance metric of the first AI model.

16. The computer-readable storage medium of claim 15, wherein an average time of the first AI model processing a message of first plurality of messages is less than an average time of the second AI model processing a message of the first plurality of messages.

17. The computer-readable storage medium of claim 15, wherein the second AI model has a higher precision that the first AI model.

18. The computer-readable storage medium of claim 15, wherein the performance metric comprises at least one of:
an F1 score for the first AI model;
a precision of the first AI model; or
a recall of the first AI model.

19. The computer-readable storage medium of claim 15, wherein the operations further comprise:
determining a baseline value of a message payload metric reflective of a feature of message payloads of a second plurality of messages;
selecting a sample of the first plurality of messages, wherein the sample comprises one or more messages of the first plurality of messages;
determining a value of the message payload metric for the sample;
determining whether the baseline value of the message payload metric and the value of the message payload metric for the sample satisfy a predefined similarity condition; and
responsive determining that the baseline value of the message payload metric and the value of the message payload metric for the sample do not satisfy the predefined similarity condition, further modifying the one or more parameters of the first AI model.

20. The computer-readable storage medium of claim 19, wherein the message payload metric is at least one of:
a message payload length reflective of a length of a message of the second plurality of messages;
an out-of-vocabulary ratio reflective of a ratio of a number of words not found in the second plurality of messages to a number of words found in the second plurality of messages;
a non-letter character ratio reflective of a ratio of text characters that are not letters to text characters that are letters; or
a word usage metric reflective of a frequency of an occurrence of a first word in used in the second plurality of messages.
